(19) United States
(12) Patent Application Publication
(10) Pub. No.: US 2025/0051019 A1
(43) Pub. Date: Feb. 13, 2025

(54) AEROSPACE FUEL CELL SYSTEM INTEGRATION

(71) Applicant: HyFlyer Powertrain, LLC, Chandler, AZ (US)

(72) Inventors: Jesse Michael Schneider, Chandler, AZ (US); Liviu Ion Cosacescu, Burnaby (CA); John R. Fulton, Chandler, AZ (US)

(21) Appl. No.: 18/720,225

(22) PCT Filed: Dec. 15, 2022
(86) PCT No.: PCT/US22/52933

§ 371 Date: Jun. 14, 2024

Related U.S. Application Data
(60) Provisional application No. 63/289,778, filed on Dec. 15, 2021.

(51) Int. Cl. B64D 27/355; B64D 27/31; B64D 33/08

(52) U.S. Cl. CPC B64D 27/355; B64D 27/31; B64D 33/08

(57) ABSTRACT

A fuel cell system configured to provide electrical power to an electrical motor producing propulsive thrust for an aircraft includes a plurality of fuel cell stacks radially arranged about a central cavity. Fuel cell plates within each of the fuel cell stacks are oriented such that major surfaces of the fuel cell plates are parallel to an airflow created by the aircraft as it moves through the air. The fuel cell system further includes a plurality of cooling devices disposed in radial cavities located between at least two fuel cell stacks in the plurality of fuel cell stacks.

### CROSS-REFERENCE TO RELATED APPLICATIONS

This application is a US National Stage Application of International Application PCT/US2022/52933 which claims priority under Article 8 of the Patent Cooperation Treaty to U.S. Provisional Patent Application 63/289,778 filed in the United States Patent and Trademark Office on Dec. 15, 2021, the entire disclosure of each of which is hereby incorporated by reference.

### TECHNICAL FIELD OF THE INVENTION

The invention relates to aircraft propulsion systems integrating a fuel cell-based electrical power system. The electrical power system supplies electrical power to a motor which provides propulsive power for the aircraft and may also supply auxiliary power to the aircraft.

### BACKGROUND

Fuel cell systems are optimized with rectangular, plate configurations in automotive and stationary applications; main requirements are power, cost, and durability, with integration under the hood or under-body, with no advantage from vehicle velocity for the air flow.

For aerospace applications, conventional systems configuration creates too many weight and space disadvantages due to their inflexibility of design and lower power densities.

### SUMMARY

In order to address the deficiencies or fuel cell systems outlined above, a fuel cell based propulsion system is described herein. The fuel cell system minimizes the number of components and integrates the component in a way that maximizes the relative air velocity (including propulsion air velocity), the range of operational temperatures and temperature rate of changes (due to the high-powered climb rates and lower power levels for descending) specific to aircraft operation.

The propulsion system includes fuel cell stack(s) that are arranged in different configurations in a nacelle mounted under, in, or near the aircraft wing. The fuel cell stack(s) power an electric motor that is disposed within the nacelle. The electric motor drives a thrust producing device such as a propeller, an air fan and/or air compressor(s). At high level analysis, this aircraft propulsion system has a function and layout similar to a conventional turbofan or turboprop engine with the fuel cell stack(s) and electric motor replacing the gas turbine. The thrust producing device may share a common drive shaft from the motor with a coolant pump configured to deliver coolant to the fuel cell stack(s) and air an air movement device configured to deliver cooling air and/or reactant air to the fuel cell stack(s).

According to one or more aspects of the present disclosure, a fuel cell system configured to provide electrical power to an electrical motor producing propulsive thrust for an aircraft includes a plurality of fuel cell stacks radially arranged about a central cavity and wherein fuel cell plates within each of the fuel cell stacks are oriented such that major surfaces of the fuel cell plates are parallel to an airflow created by the aircraft as it moves through the air. The fuel cell system also includes a plurality of cooling devices disposed in radial cavities located between at least two fuel cell stacks in the plurality of fuel cell stacks.

According to one or more aspects of the present disclosure, an aircraft includes a fuel cell system mounted within a nacelle on the aircraft, an electrical motor powered by the fuel cell system having a drive shaft, an air movement device connected to the drive shaft and configured to provide reactant air to fuel cell plates in the fuel cell system, and a propeller located external to the nacelle and connected to the drive shaft. The propeller is configured to provide propulsive thrust for the aircraft.

In some aspects of the aircraft described in the preceding paragraph, a plurality of air movement devices is connected with the drive shaft in common with the propeller.

In some aspects of the aircraft described in the preceding paragraph, the plurality of air movement devices is selected from a list consisting of a propeller, an axial compressor, a radial compressor, and a fan.

According to one or more aspects of the present disclosure, an aircraft includes a fuel cell system mounted within the aircraft, an electrical motor powered by the fuel cell system having a drive shaft, a thrust producing device connected to the drive shaft and configured to pressure air within a nacelle and to provide reactant air to the fuel cell system, and a bypass chamber in a nacelle configured to route a portion of air accelerated by the thrust producing device such that it bypasses the fuel cell system. This air accelerated by the thrust producing device provides propulsive thrust for the aircraft as it exits the nacelle.

According to one or more aspects of the present disclosure, a method of operating a fuel cell system configured to provide electrical power to an electrical motor producing propulsive thrust for an aircraft includes setting a thermostatic valve configured to direct coolant from a coolant loop to a heat exchanges producing hydrogen to a fuel cell in in bypass-open mode upon start-up of the fuel cell system, thereby bypassing a gasifying heat exchanger and, directing coolant back through the fuel cell, thus improving warm-up rate.

### BRIEF DESCRIPTION OF THE DRAWINGS

The present invention is described, by way of example with reference to the accompanying drawings, in which:

FIG. 1 is a schematic diagram a fuel cell system of an aircraft propulsion system according to some embodiments;

FIG. 2 is a schematic diagram of a front view of an aircraft propulsion system according to some embodiments;

FIG. 3 a schematic diagram of an airplane wing incorporating an aircraft propulsion system according to some embodiments;

FIGS. 4A and 4B are schematic views an airplane wing incorporating retractable cooling fins for the fuel cell system according to some embodiments;

FIG. 5 is a schematic diagram of a side view of another aircraft propulsion system according to some embodiments;

FIG. 6 a schematic diagram of an airplane wing incorporating another aircraft propulsion system according to some embodiments;

FIGS. 7A and 7B are schematic diagrams of a blended wing aircraft incorporating the aircraft propulsion system of FIG. 6 according to some embodiments;

FIG. 8 is a schematic diagram of a side view of another aircraft propulsion system according to some embodiments;

FIG. 9A is a schematic diagram of a rear view of the aircraft propulsion system of FIG. 8 according to some embodiments;

FIG. 9B is a close-up detail view of the aircraft propulsion system of FIG. 9A according to some embodiments;

FIG. 10 is a schematic diagram of a side view of a liquid hydrogen storage tank according to some embodiments

FIG. 11A is a schematic diagram of a side view of an aircraft having tail mounted ammonia storage tanks according to some embodiments;

FIG. 11B is a close-up detail view of an ammonia storage tank of FIG. 11A according to some embodiments;

FIG. 12A is a schematic diagram of a side view of an aircraft having tail mounted methanol storage tanks according to some embodiments; and

FIG. 12B is a close-up detail view of a methanol storage tank of FIG. 12A according to some embodiments;

FIG. 13A is a schematic diagram of a side view of an aircraft having tail mounted liquid hydrogen storage tanks according to some embodiments;

FIG. 13B is a close-up detail view of a heat exchanger of FIG. 13A according to some embodiments;

FIG. 14 is a schematic diagram of a side view of an aircraft having tail mounted gaseous hydrogen storage tanks according to some embodiments;

FIG. 15 is a table of operating parameters of various operating modes according to some embodiments;

FIG. 16 is a schematic diagram of a side view of a cryogenically cooled hydrogen storage tank according to some embodiments.

FIG. 17A is a schematic diagram of a side view of an aircraft having tail mounted cryogenically cooled hydrogen storage tanks according to some embodiments;

FIG. 17B is a close-up detail view of a heat exchanger of FIG. 17A according to some embodiments;

FIG. 18 is a table of operating parameters of various operating modes according to some embodiments.

FIG. 19 is a schematic diagram of a side view of a subcooled liquid hydrogen storage tank according to some embodiments

FIG. 20A is a schematic diagram of a side view of an aircraft having tail mounted subcooled liquid hydrogen storage tanks according to some embodiments;

FIG. 20B is a close-up detail view of a heat exchanger of FIG. 20A according to some embodiments;

FIG. 21 is a table of operating parameters of various operating modes according to some embodiments.

### DETAILED DESCRIPTION

This patent application describes a fuel cell-based aircraft propulsion system that is usable for diverse types of aircraft.

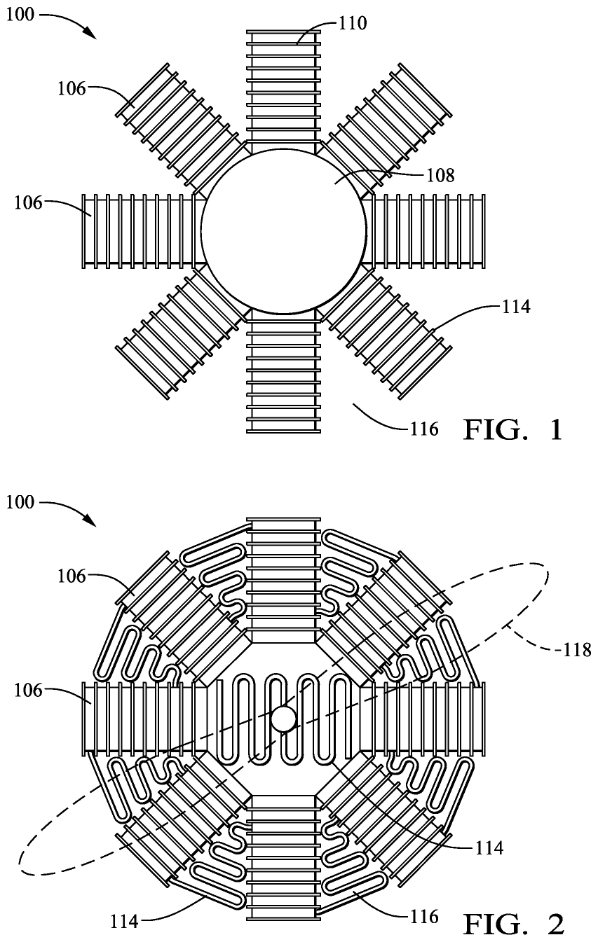

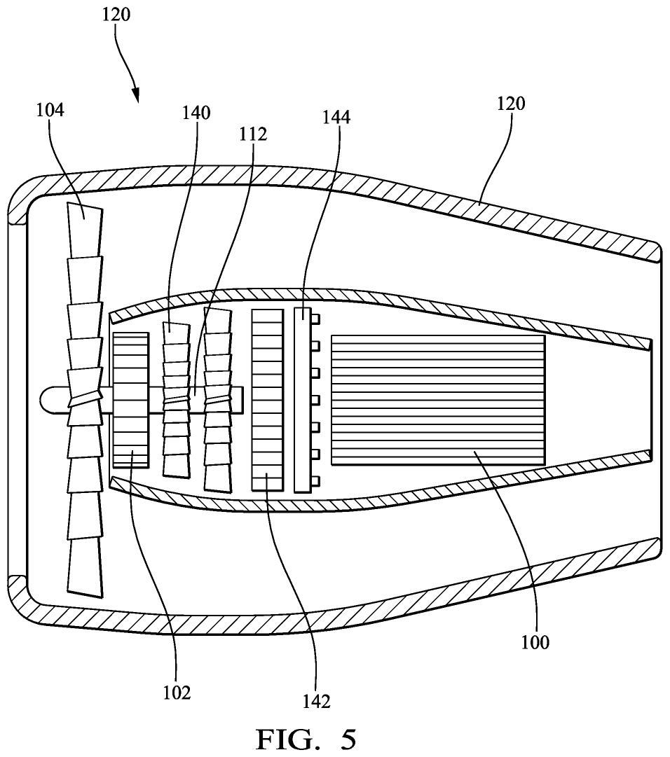

FIG. 1 shows a fuel cell system 100 suitable for use in an aircraft propulsion system. The fuel cell system 100 provides electrical power to an electrical motor 102 which produces propulsive thrust for the aircraft by turning a thrust producing device 104, such as a propeller, fan, turbine, or compressor as shown in FIG. 5. The fuel cell system may also provide auxiliary electrical power to the aircraft, e.g., for control, communication, and navigation systems. The fuel cell system may additionally provide auxiliary thermal power to the aircraft for cabin heating, etc.

The fuel cell system 100 includes a plurality of fuel cell stacks 106 radially arranged about a central cavity 108. The fuel cell plates within each of the fuel cell stacks are oriented such that major surfaces of the fuel cell plates 110 are arranged parallel to an airflow created by the aircraft as it moves through the air, thereby allowing cooling or reactant air for the fuel cell plates 110 to flow thorough the fuel cell stacks 106. The fuel cell system 100 may require additional air movement devices, e.g., the thrust producing device 104, to provide sufficient cooling or reactant air for the fuel cell plates 110 to flow through the fuel cell stacks 106. These additional air movement devices may also be powered by the motor 102 and share a common drive shaft 112 with the thrust producing device 104.

As shown in FIG. 2, the fuel cell system also includes a plurality of cooling devices 114 that are disposed in radial cavities 116 located between the fuel cell stacks 106. The cooling devices 114 may be ducts that route air flowing through the radial cavities 116 into the fuel cell stacks 106 to produce additional cooling or reactant air to the fuel cell plates 110. The cooling devices 114 may be cooling fins that are formed of a material with high thermal conductivity, e.g., aluminum, which are disposed within an airstream to conduct heat away from the fuel cell stacks 106. Alternatively, the cooling devices may be radiators or heat exchangers having a liquid or gaseous coolant flowing through them to carry waste heat away from the fuel cell stacks 106. The coolant may contain air, water, ice water (i.e., a mixture of ice and water), oil, liquid hydrogen, gaseous hydrogen, or any other suitable liquid or gaseous coolant. The cooling devices 114 may also be placed between the fuel cell stacks 106 and the thrust producing device, to the right, to the left, above or below the fuel cell system 100, or may be located remotely from the fuel cell system 100.

A coolant reservoir may be disposed within the central cavity 108. Non-potable water from the cooling system, including melted ice water, may be used on board the aircraft for utilities, e.g., hand washing, toilet flushing, etc. Alternatively, the central cavity 108 may include another, separate, cooling device. This coolant reservoir is integrated with the aircraft water system and is separate from the fuel cell's coolant system.

As illustrated in FIG. 2, the drive shaft 112 from the electric motor 102 may extend through the central cavity 108 from the motor 102 located behind the fuel cell stack 106 to a propeller 118.

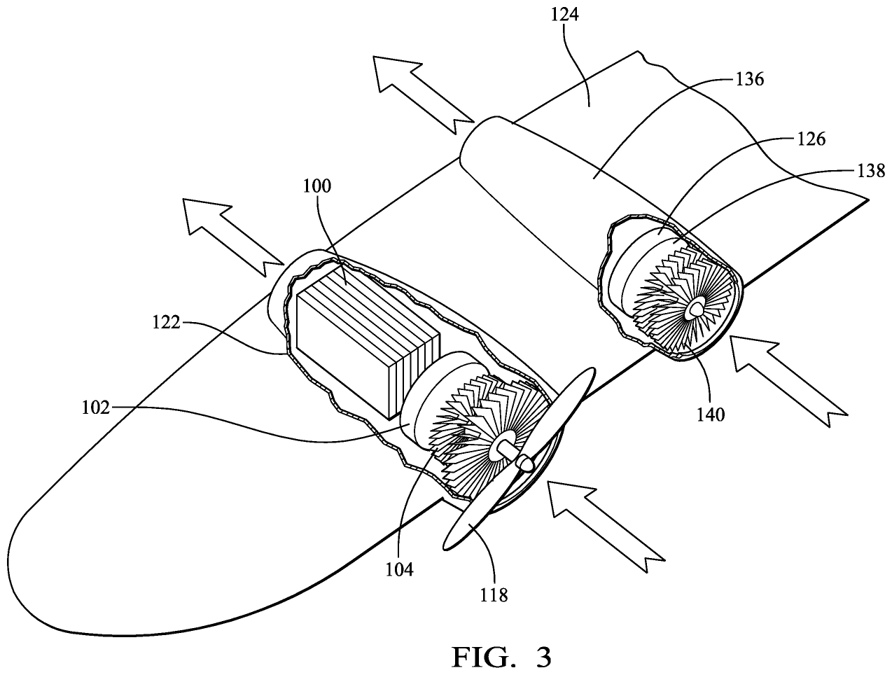

As shown in FIG. 3, an aircraft propulsion system 120 including the fuel cell system 100 is contained in a nacelle 122 located in, under, or near the wing 124 of the aircraft. The propulsion system 120 is arranged so that the motor 102 is located at the forward end of the nacelle 122 and is connected by the drive shaft 112 to the thrust producing device 104. The fuel cell system 100 is mounted centrally in the nacelle 122 and has the bipolar plates mounted horizontally with the flow field in the aircraft's longitudinal direction and are arranged parallel to the air flow. The fuel cell system 100 in this embodiment may be the radially arranged fuel cell system shown in FIGS. 1 and 2 or it may be a fuel cell stack or plurality of fuel cell stacks arranged in a different configuration. A thrust producing device 104, e.g., a fan, compressor, or other air movement device, is also connected to the motor's drive shaft 112 and is located immediately rearward of the motor 102. This thrust producing device 104 provides cooling/and or reactant air to the fuel cell stack 106, and cooling devices 114 for the reactant air, fuel cell system, motor and/or other electronics in the aircraft. In one embodiment the reactant air flows straight into the air flow field, without being directed through stack porting. As further shown in FIG. 3, the cooling devices 114 or additional cooling devices 126 for the fuel cell stack 106, motor 102, and/or other electronics may be located in a second, separate nacelle 136 and rely strictly on airflow from the forward movement of the aircraft. Although not shown, the aircraft propulsion system 120 shown in FIG. 3 may be duplicated on the opposite side of the aircraft.

If a low pressure fuel cell system is used, the air movement device may be a fan. If a high pressure fuel cell system is used, the air movement device may be a compressor.

Air heated by the fuel cell system 100 and/or the cooling devices 114 may provide additional thrust as it exits the nacelle to offset a portion of the aerodynamic drag caused by the cooling devices in a manner known as the Meredith effect.

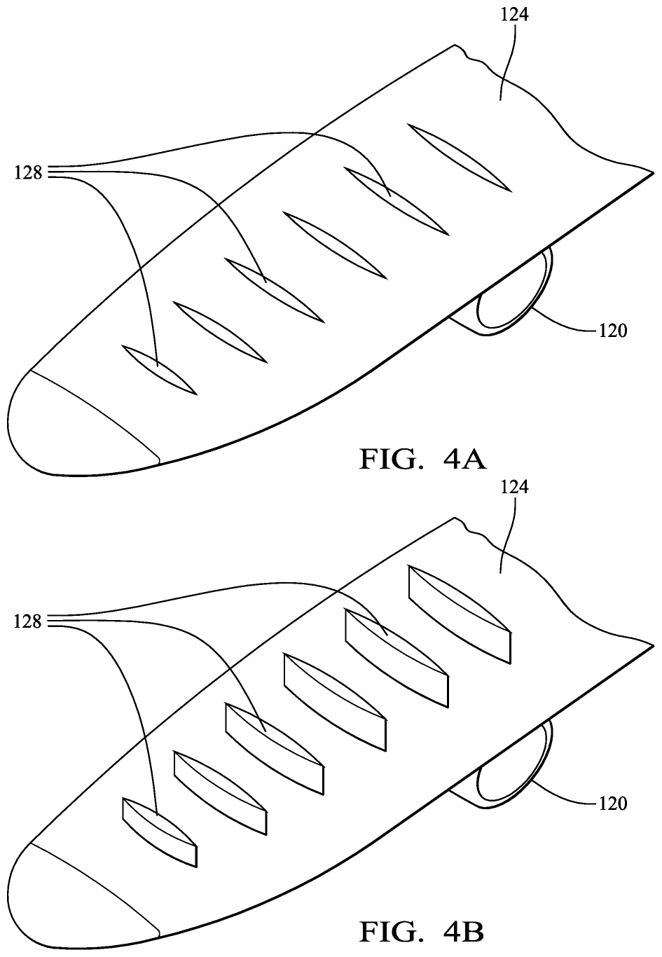

As shown in FIGS. 4A and 4B, the wing 124 may be used as a heat sink for the coolant from the fuel cell system 100. Aircraft wings formed of aluminum have a high thermal conductivity. In order to deal with high thermal loads on the fuel cell system 100 during takeoff and climbing phases of a flight, the wings 124 may include retractable cooling fins 128 that extend from the wings and/or control surfaces in order to dissipate the excess heat from the fuel cell system. Of course, the shape, placement, and orientation of the retractable cooling fins 128 have to be chosen with a consideration of aerodynamic drag that the retractable cooling fins 128 may generate. Alternately, or in addition, ice water may be used as a liquid coolant during takeoff due to the additional heat energy that can be absorbed from the fuel cell system 100 as ice in the ice water melts. The melt water from the ice may then be used onboard the aircraft for utilities such as toilet flushing, hand washing, etc. The highest demand for cooling happens during takeoff and climbing to altitude. Once cruising altitude is reached, the low ambient air temperature reduces demand for cooling from the cooling devices.

FIG. 5 shows an aircraft propulsion system having a fuel cell system 100 with the balance of the plant and propulsion system attached in a typical turbofan jet engine configuration with the fuel cell system 100 and electric motor 102 replacing the jet engine's turbine and combustion chambers. The propulsion system is preferably located in the wing box area. A thrust producing device 104 in the form of a fan is located in the forward portion of the nacelle 122 ahead of the motor 102 and is configured to accelerate air within the nacelle 122 to provide thrust. The propulsion system may also include a gear box (not shown) between the motor 102 and thrust producing device 104. The motor 102 may also drive a separate air movement device 140 that produces reactant and/or cooling air for the fuel cell system 100 and a coolant pump 142 to circulate coolant through the cooling device 114. The propulsion system may also include a water injection system 144 to introduce humidity into the reactant air stream and/or cool the fuel cell stacks. A portion of the air accelerated by the fan is ducted to bypass the motor, air movement device, fuel cell system, and coolant pump. Similar to a turbofan jet engine, this aircraft propulsion system uses a bypass ratio in the range of at least 3:1 to more than 12:1.

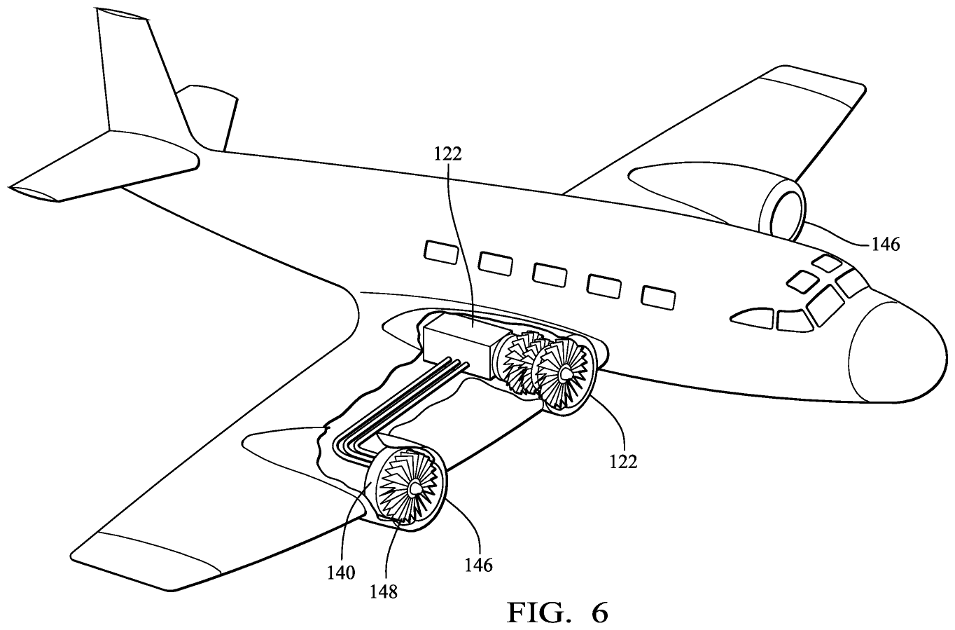

FIG. 6 shows another embodiment in which a main portion of the propulsion system including the fuel cell system is located in a first nacelle 122 near the wing root, similar to the de Havilland Comet or the Lockheed P-80 Shooting Star, or within the body of the aircraft, similar to the General Dynamics F-16 Falcon. The propulsion system also includes an auxiliary portion that is located in a second nacelle 146 located on or under the wing 124. This secondary portion includes a second motor 148 electrically connected to the fuel cell system 100 that drives a second thrust producing device 140, such as a propeller, fan, or compressor. The second nacelle 146 does not contain a fuel cell system, but could include cooling devices for the second motor, the fuel cell system, and/or other electronics in the aircraft. Although not shown, the aircraft propulsion system shown in FIG. 6 may be duplicated on the opposite side of the aircraft. This configuration may also allow thrust vectoring by modulating the thrust from the first and second nacelles 122, 146.

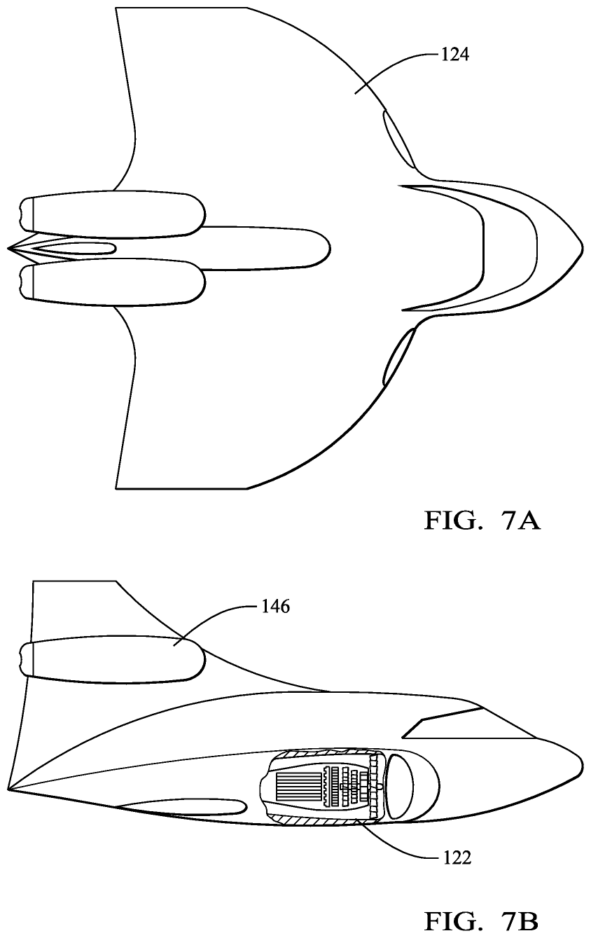

FIGS. 7A and 7B illustrate an example of the propulsion system of FIG. 6 incorporated into a blended wing aircraft design. The main portion of the propulsion system is located near the root wing or within the body of the aircraft. The auxiliary portions of the propulsion system are located in nacelles located in an aft portion of the aircraft, e.g., near the tail.

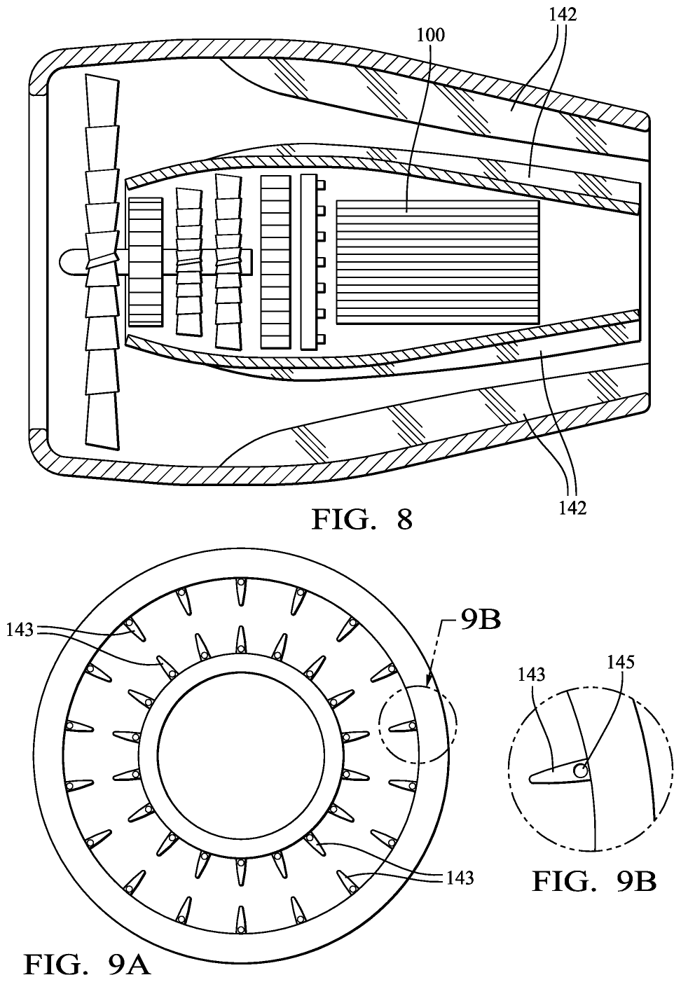

FIGS. 8, 9A, and 9B illustrate another example of an aircraft propulsion system having a fuel cell system in a typical turbofan jet engine configuration. This example includes a plurality of cooling fins 143 for the fuel cell system 100 that are arranged around the interior of the nacelle 122 so that they are located in the propulsion air stream to provide cooling for the fuel cell system 100 and also heat air in the nacelle 122 to provide additional thrust via the Meredith effect. The cooling fins 143 may include ducts 145 through which a liquid coolant, such as a glycol solution, may circulate between the cooling fins 143 and the fuel cell stacks.

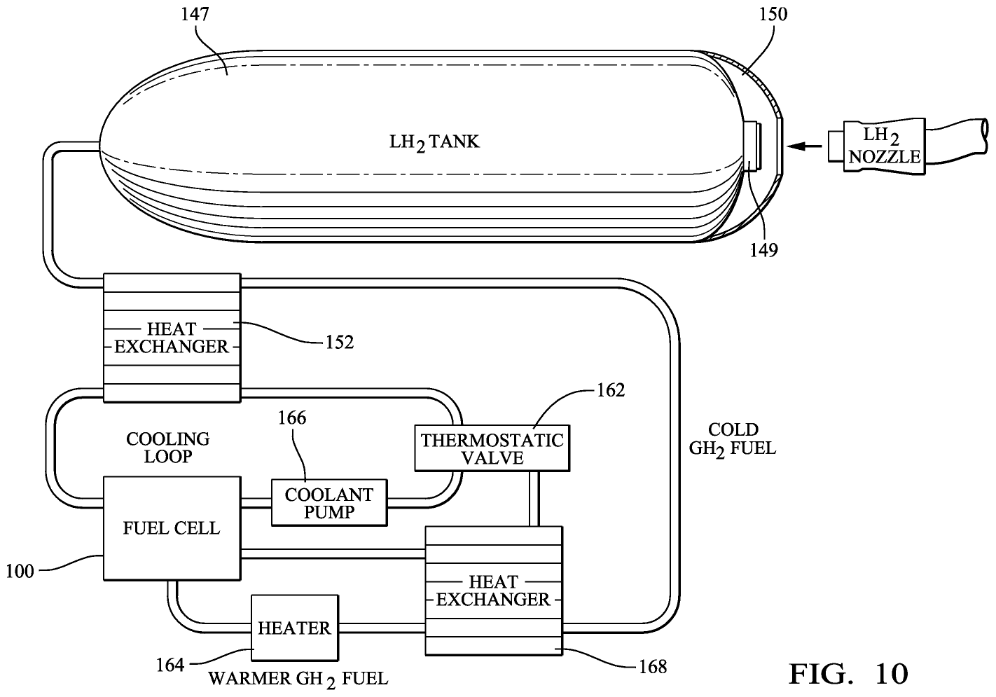

As shown in FIG. 10, a liquid hydrogen storage tank 147 is connected to one or more heat exchangers 152. 168 that heats the liquid hydrogen to become gaseous hydrogen useable by the fuel cell stacks 106 of the fuel cell system 100. A coolant, such as a glycol-based coolant, is heated by the fuel cell stacks 106 and is used to heat the liquid hydrogen. The temperature of the coolant is reduced during this process reducing the amount of energy required to cool the fuel cell system and is returned to the fuel cell stacks 106 to provide cooling thereof.

As shown in FIG. 16, a cryogenically cooled hydrogen storage tank 170 is connected to one or more heat exchangers 152. 168 that heats the liquid hydrogen to become gaseous hydrogen useable by the fuel cell stacks 106 of the fuel cell system 100. A coolant, such as a glycol-based coolant, is heated by the fuel cell stacks 106 and is used to heat the liquid hydrogen. The temperature of the coolant is reduced during this process reducing the amount of energy required to cool the fuel cell system and is returned to the fuel cell stacks 106 to provide cooling thereof.

As shown in FIG. 19, a subcooled cooled hydrogen storage tank 172 is connected to one or more heat exchangers 152. 168 that heats the liquid hydrogen to become gaseous hydrogen useable by the fuel cell stacks 106 of the fuel cell system 100. A coolant, such as a glycol-based coolant, is heated by the fuel cell stacks 106 and is used to heat the liquid hydrogen. The temperature of the coolant is reduced during this process reducing the amount of energy required to cool the fuel cell system and is returned to the fuel cell stacks 106 to provide cooling thereof.

Operating Mode 1—Cold Start, Idle, Cold Ambient: ambient temperature less than 0° C., low coolant flow for quick startup until fuel cell temperature exceeds 0° C., H₂ gasify and warmup by H₂ heater 164 until the fuel cell temperature reaches operating temperature.

Operating Mode 2—Cold Start, Idle, Hot Ambient: ambient temperature greater than 30° C., coolant flow bypass, H₂ warmup by H₂ heater 164 until the fuel cell temperature reaches operating temperature.

In Operating Modes 1 and 2, while the aircraft is on the tarmac and upon start-up of the fuel cell, the thermostatic valve 162 is in bypass-open mode, thereby bypassing the gasifier heat exchanger 168 and directing the coolant back through the fuel cell, thus improving warm-up rate. For the cold ambient temperature conditions of Operating Mode 1, the H₂ heater 164 can be modulated to provide supplemental hydrogen fuel heating power, and the electric coolant pump 166 can also be modulated to augment the fuel cell warming process.

Operating Mode 3—Taxiing, Low Power, Cold Ambient: coolant heater on, thermostatic valve 162 bypass open, H₂ warmup by H₂ heater 164

Operating Mode 4—Taxiing, Low Power, Hot Ambient: H₂ warmup by H₂ heater 164

In operating modes 3 and 4, while the aircraft is taxiing on the runway, once the fuel cell 100 has been warmed to an optimal operating temperature, in a cold ambient condition, the thermostatic valve 162 can still be in closed/bypass-open mode, or conversely for a hot ambient condition it may be in the open/bypass-closed closed mode thus affording some heat transfer to augment hydrogen gasification. Supplemental heating, and coolant pump modulation are also available to balance the system as desired by control system design.

Operating Mode 5—Take Off/Maneuver, Full Load, Cold Ambient: maximum fuel cell 100 power, maximum cooling needed, H₂ heated by coolant loop.

Operating Mode 6—Take Off/Maneuver, Full Load, Hot Ambient: maximum fuel cell 100 power, maximum cooling needed, H₂ heated by coolant loop.

In operating modes 5 and 6, during take-off, the fuel cell 100 power is maximum so with the fuel generating maximum heat also, the thermostatic valve 162 will be in open/bypass-closed mode, affording heat transfer for hydrogen gasification, such that modulation of the coolant pump 166 and H₂ heater 164 may be adjusted to balance the system as desired by control system design.

Operating Mode 7—Level Flight, Medium Load, Cold Ambient: coolant loop pump 166 on, H₂ heater 164 modulated.

Operating Mode 8—Level Flight, Medium Load, Hot Ambient: coolant loop pump 166 on, H₂ heater 164 modulated.

In operating modes 7 and 8, during level flight with a medium load, the fuel cell 100 power may conceivably be operating at a level less than maximum power, so the thermostatic valve 162, the coolant pump 166 and the H₂ heater 164 may similarly be modulated to balance the system as desired by control system design.

Operating Mode 9—Level Flight, Low Load, Cold Ambient: coolant loop pump 166 on, H₂ heater 164 modulated.

Operating Mode 10—Level Flight, Low Load, Hot Ambient: coolant loop pump 166 on, H₂ heater 164 modulated.

In operating modes 9 and 10, during level flight with a low load, the fuel cell 100 power may conceivably be operating at an even lower power level, so the thermostatic valve 162, the coolant pump 166 and the H₂ heater 164 may similarly be modulated to balance the system as desired by control system design.

Operating Mode 12—Descending, Low Power, Cold Ambient: coolant loop bypass/selective stack operation if multiple stacks.

Operating Mode 12—Descending, Low Power, Hot Ambient: coolant loop bypass

In operating modes 9 and 10, while descending, at low power depending on the ambient temperature conditions, the thermostatic valve 162 may be for a cold ambient condition be in the closed/bypass-open mode, or conversely for a hot ambient condition it may be in the open/bypass-closed mode thus affording some heat transfer to augment hydrogen gasification, and the coolant pump 166 and H₂ heater 164 may both be modulated to further maintain the thermal conditions of the system as desired by control system design.

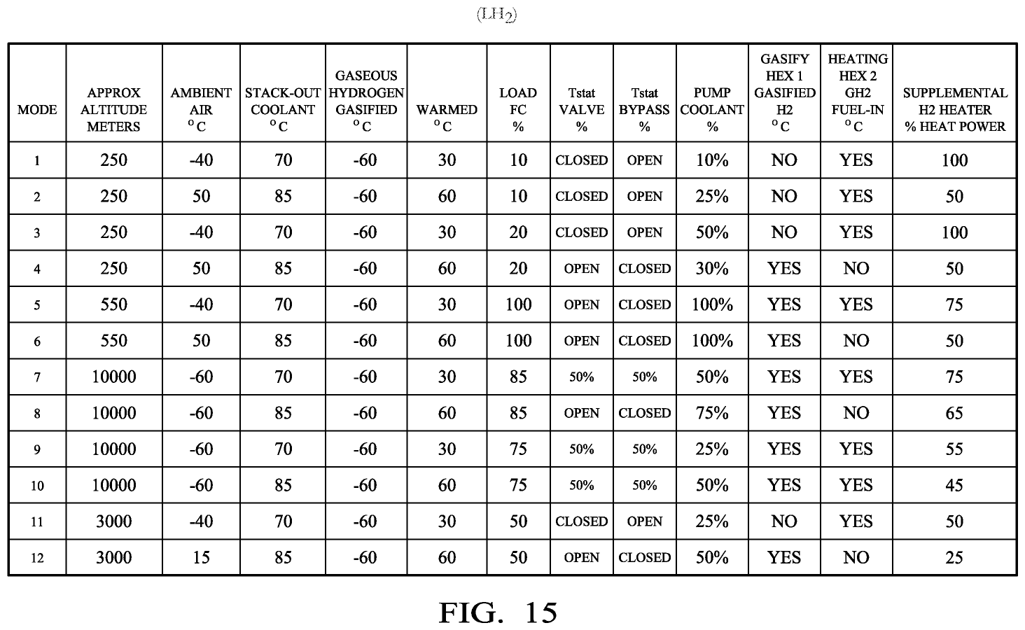

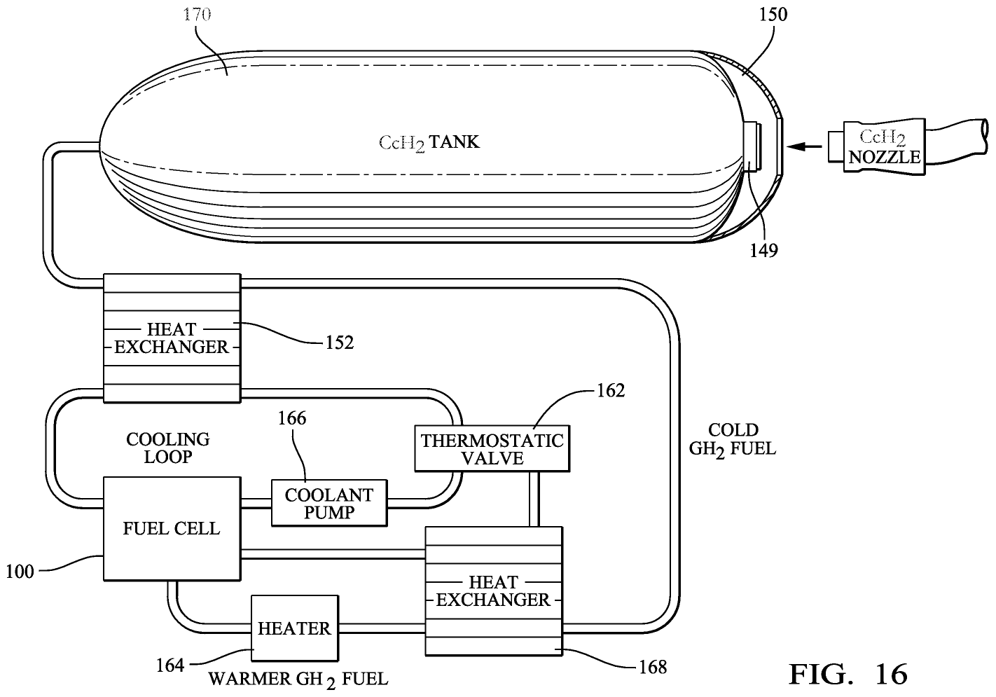

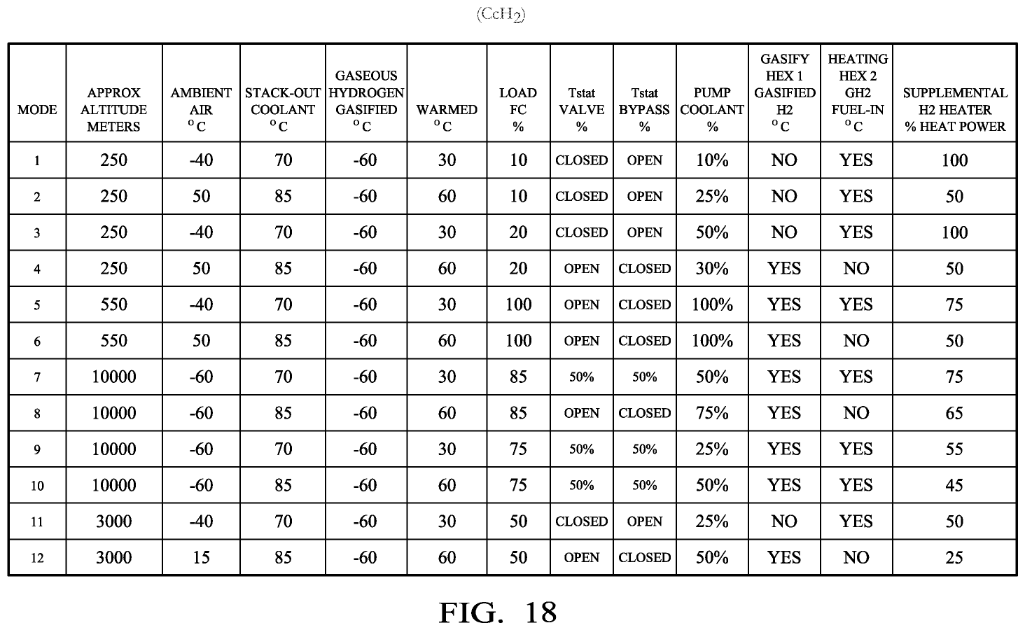

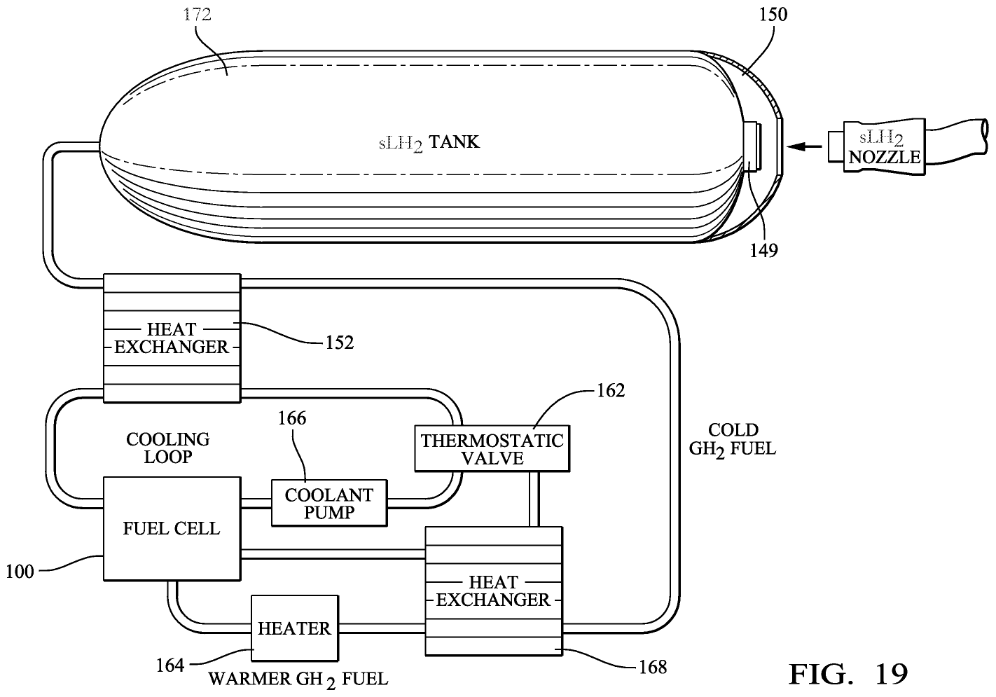

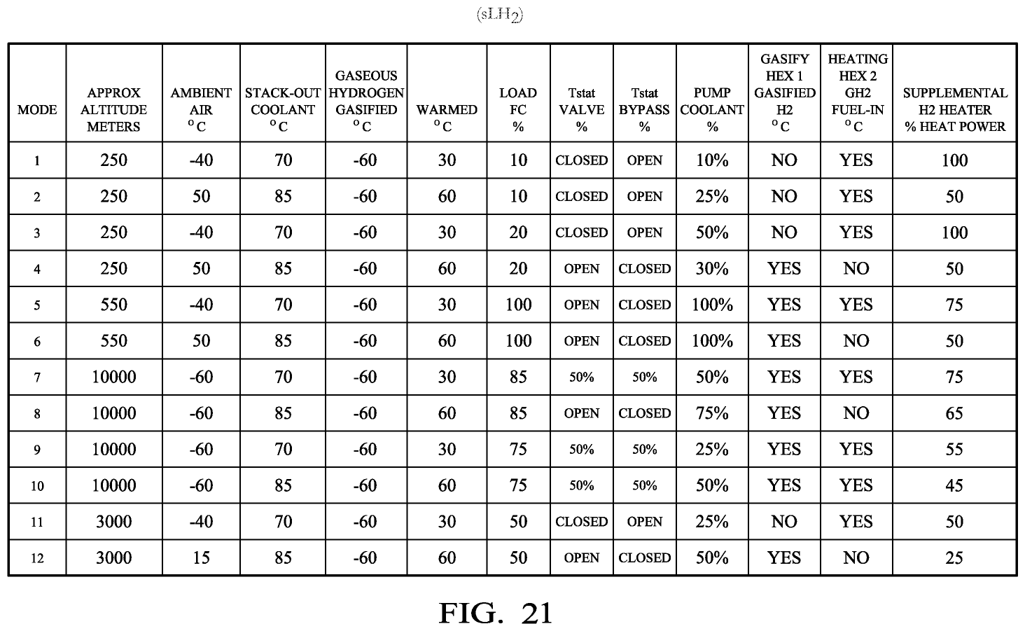

Further details of conditions for Operating Modes 1 through 12 may be found in FIGS. 15, 18, and 21.

Examples of hydrogen storage standards are Society of Automotive Engineers (SAE) standard SAE J2579 and International Organization for Standards (ISO) 20421-1; receptacles/nozzles standards SAE J2600, ISO 17268, and ISO 45; hydrogen fueling standards SAE J2601 and ISO Publicly Available Specification (PAS) 15594. airport hydrogen fueling facility operations, ground support equipment for liquid hydrogen standards National Aeronautics and Space Administration (NASA) KSC-STD-Z-0009 and KSC-STD-Z-0005B.

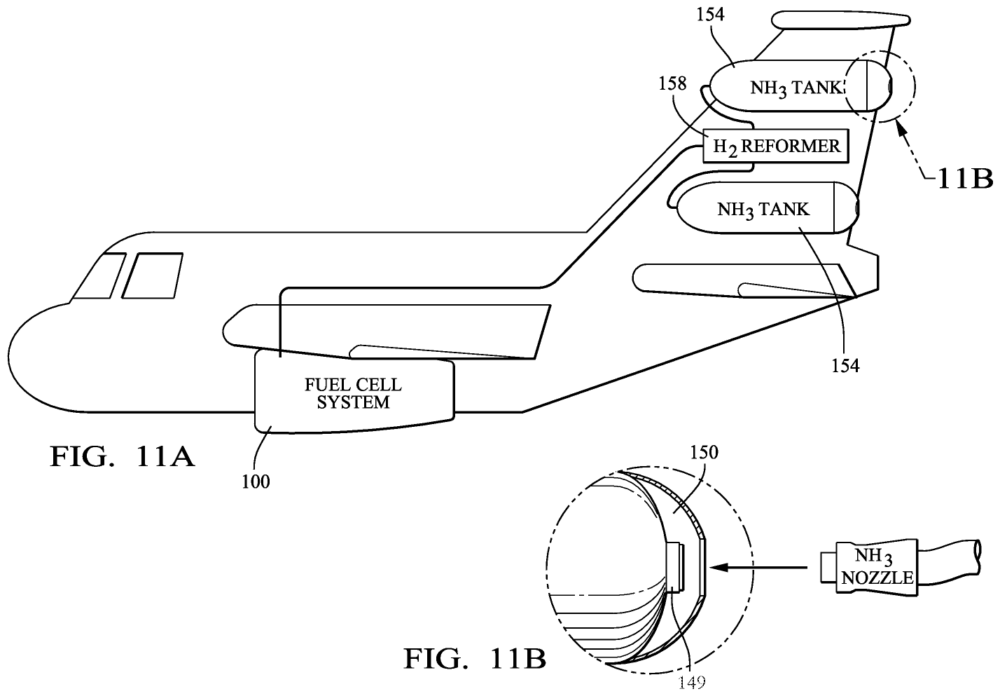

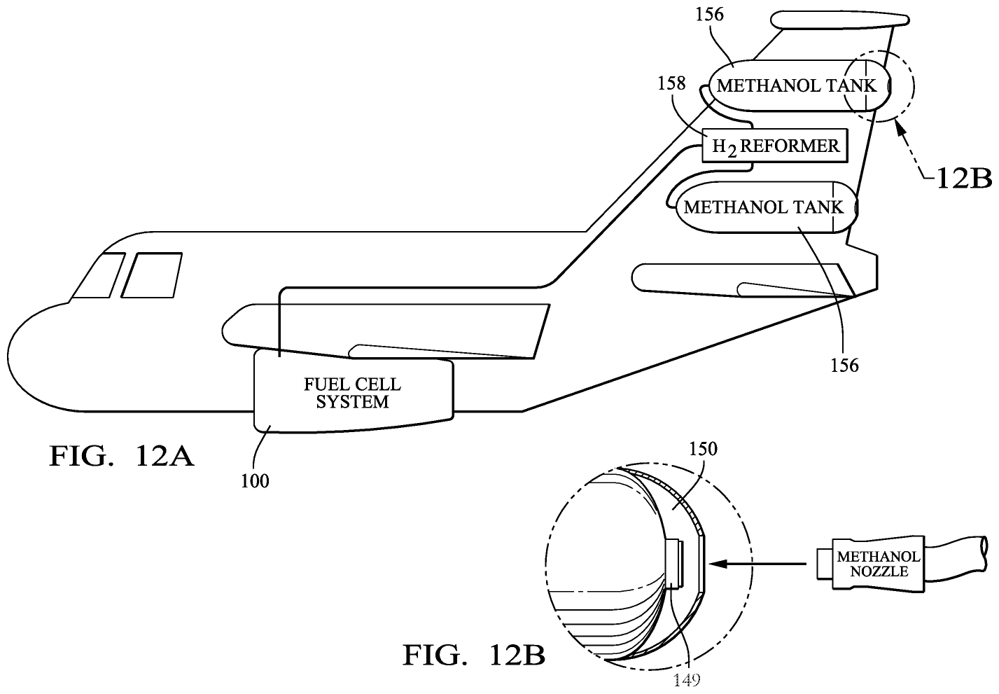

FIGS. 11A, 11B, 12A, and 12B illustrate aircraft with a fuel cell propulsion system that includes a number of liquid ammonia (NH₃) or methanol (CH₃OH) storage tanks 154, 156 located near the tail of the aircraft in a configuration similar to the engine layout of a McDonnell-Douglas MD-11. The liquid ammonia (NH₃) or methanol (CH₃OH) storage tanks 154, 156 include fueling ports 149 located near the aft end of the tanks 154, 156. The fueling ports 149 have an integrated aerodynamic cover 150. These aircraft configurations also include an integral reformer 158 configured to liberate gaseous hydrogen from the liquid ammonia or methanol that is usable by the fuel cell stacks. The heat generated by the integral reformer 158 may be used to heat the fuel cell system 100 during a cold start phase. These ammonia and methanol storage tanks 154, 156 also include fueling ports 149 with an integrated aerodynamic cover 150 on an aft portion of the tanks 154, 156.

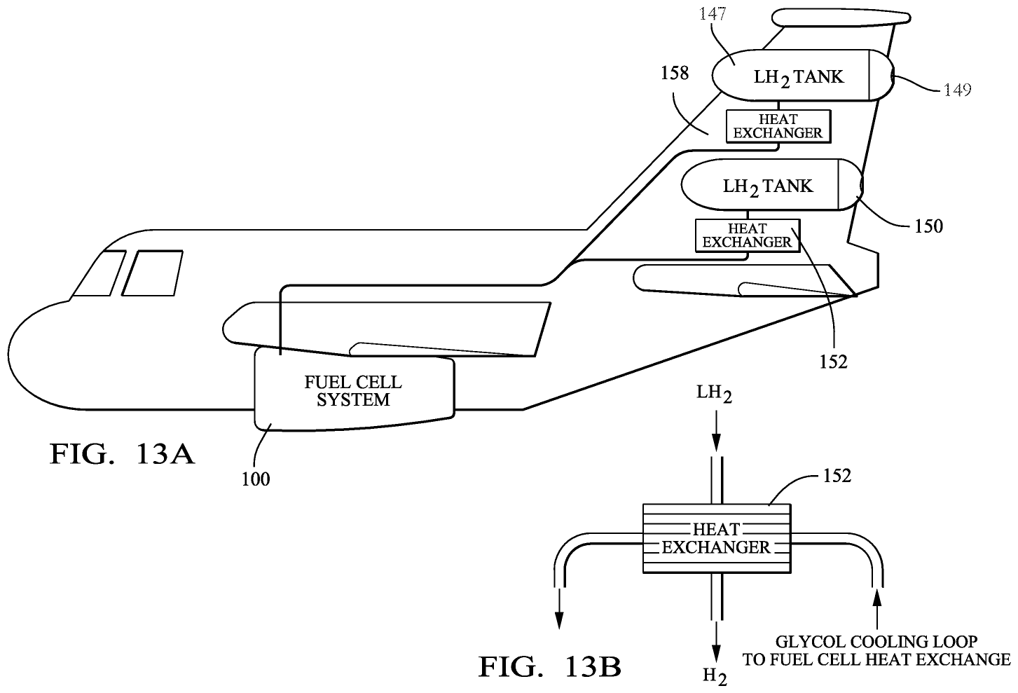

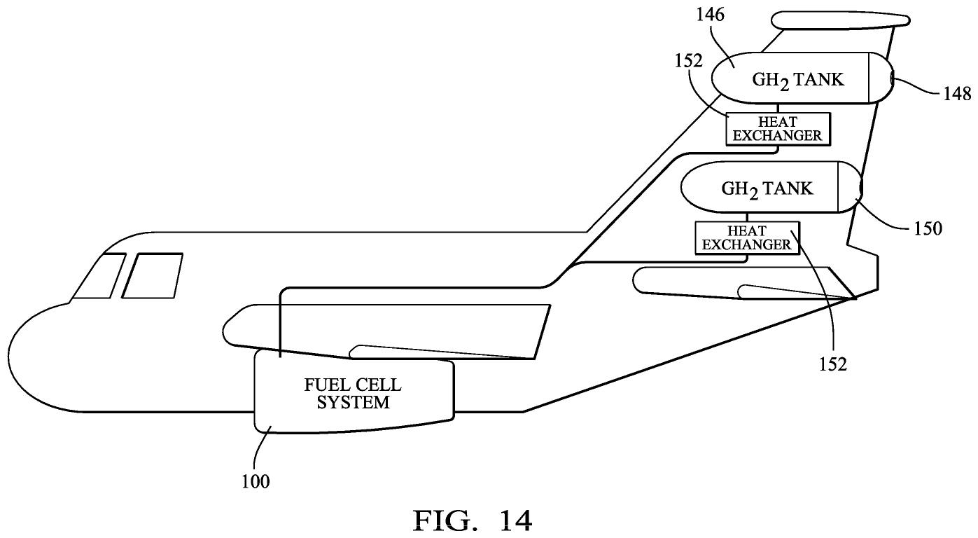

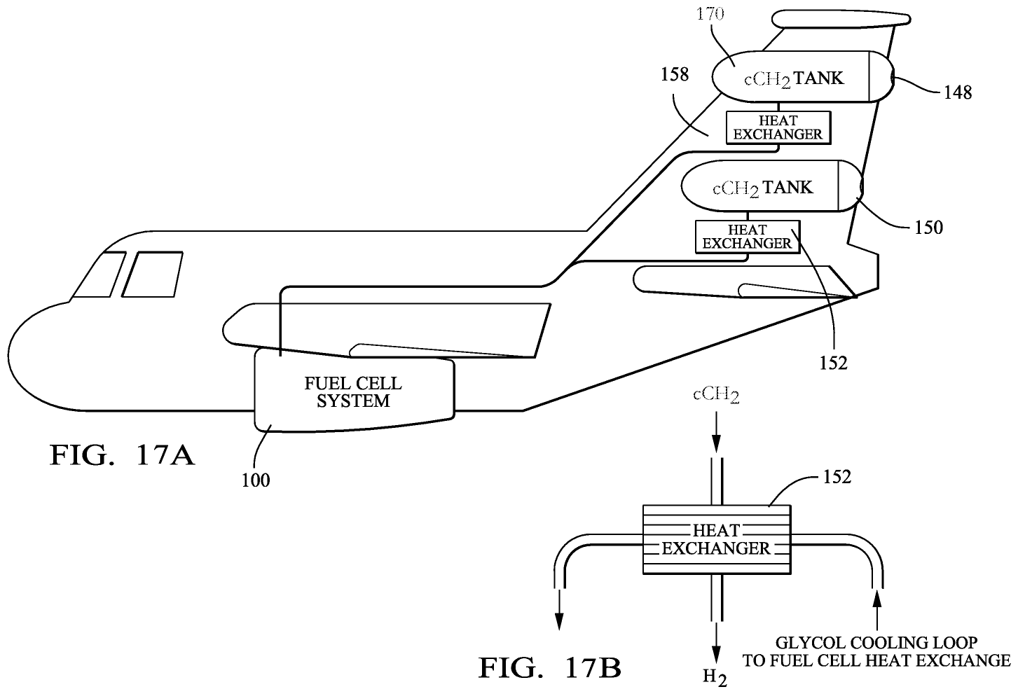

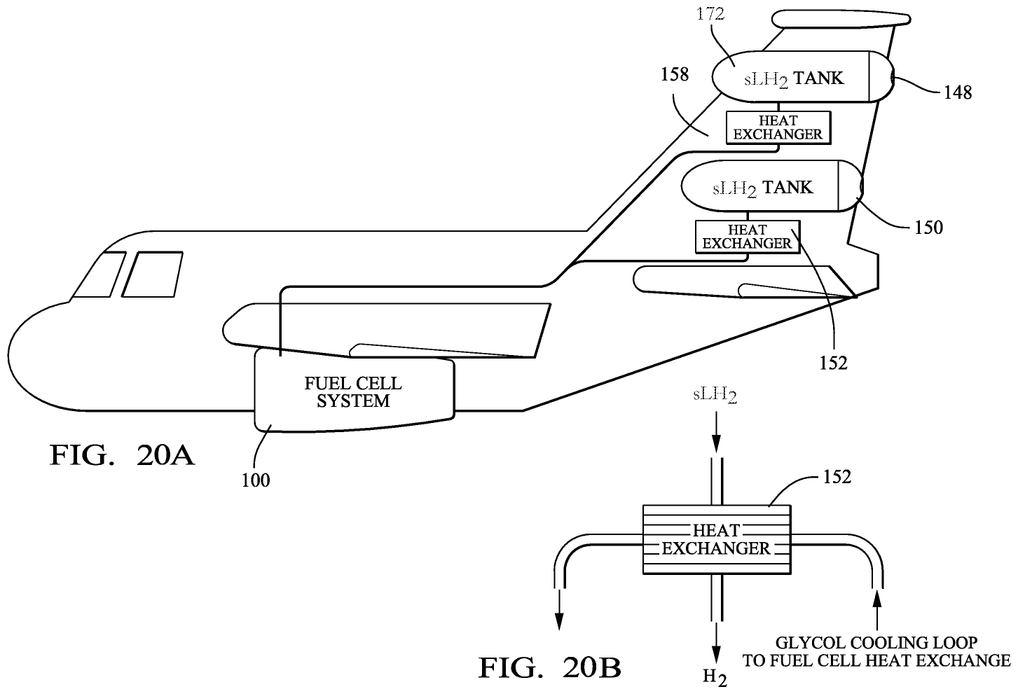

FIGS. 13A, 13B, 14, 17A, 17B, 20A and 20B illustrate a similar aircraft configurations to FIGS. 11A, 11B, 12A, and 12B which include liquid hydrogen (LH₂) storage tanks 147, gaseous hydrogen (GH₂) storage tanks 160, cryogenically cooled hydrogen (CcH₂), cryogenically cooled hydrogen (CcH₂) storage tanks 160, or subcooled liquid hydrogen (CcH₂) storage tanks 172 in the same locations as the liquid ammonia (NH₃) or methanol (CH₃OH) storage tanks 154, 156. These liquid hydrogen storage tanks 147 or gaseous hydrogen storage tanks 160 also include fueling ports 149 with an integrated aerodynamic cover 150 on an aft portion of the tanks 160.

While the example of the fuel cell system 100 presented herein is incorporated a fixed winged aircraft, other embodiments of the system 100 may be incorporated into other aircraft such as acrostats, e.g., blimps or dirigibles, or other acrodynes, e.g., helicopters, autogiros, variable sweep wing, or flexible wing aircraft.

While this invention has been described in terms of the preferred embodiments thereof, it is not intended to be so limited, but rather only to the extent set forth in the claims that follow. For example, the above-described embodiments (and/or aspects thereof) may be used in combination with each other. In addition, many modifications may be made to configure a particular situation or material to the teachings of the invention without departing from its scope. Dimensions, types of materials, orientations of the various components, and the number and positions of the various components described herein are intended to define parameters of certain embodiments and are by no means limiting and are merely prototypical embodiments.

Many other embodiments and modifications within the spirit and scope of the claims will be apparent to those of skill in the art upon reviewing the above description. The scope of the invention should, therefore, be determined with reference to the following claims, along with the full scope of equivalents to which such claims are entitled.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order, order of operations, direction or orientation unless stated otherwise.

### Clauses:

Clause 1. A fuel cell system configured to provide electrical power to an electrical motor producing propulsive thrust for an aircraft, including: a plurality of fuel cell stacks radially arranged about a central cavity and wherein fuel cell plates within each of the fuel cell stacks are oriented such that major surfaces of the fuel cell plates are parallel to an airflow created by the aircraft as it moves through the air; and a plurality of cooling devices disposed in radial cavities located between at least two fuel cell stacks in the plurality of fuel cell stacks.

Clause 2. The fuel cell system according to clause 1, wherein the airflow is directed between the fuel cell plates to provide reactant air to the fuel cell plates.

Clause 3. The fuel cell system according to clause 1 or 2, wherein the plurality of cooling devices is configured to direct the airflow between the fuel cell plates.

Clause 4. The fuel cell system according to clause 3, wherein the cooling devices contain a coolant.

Clause 5. The fuel cell system according to clause 4, wherein a reservoir for the coolant is disposed within the central cavity.

Clause 6. The fuel cell system according to clause 4 or 5, wherein the coolant is selected from a list consisting of air, water, ice water, oil, glycol-based coolant, liquid hydrogen, and gaseous hydrogen.

Clause 7. The fuel cell system according to clause 4, 5, or 6 further includes a separate cooling device disposed within the central cavity.

Clause 8. An aircraft, including: a fuel cell system mounted within a nacelle on the aircraft; an electrical motor powered by the fuel cell system having a drive shaft; an air movement device connected to the drive shaft and configured to provide reactant air to fuel cell plates in the fuel cell system; and a propeller located external to the nacelle and connected to the drive shaft, wherein the propeller is configured to provide propulsive thrust for the aircraft.

Clause 9. The aircraft according to clause 8, wherein a plurality of air movement devices is connected with the drive shaft in common with the propeller.

Clause 10. The aircraft according to clause 9, wherein the plurality of air movement devices is selected from a list consisting of a propeller, an axial compressor, a radial compressor, and a fan.

Clause 11. The aircraft according to clause 9 or 10, wherein the plurality of air movement devices is disposed in a location selected from a list consisting of coaxial with, above, below, left, and right of the fuel cell system.

Clause 12. The aircraft according to any one of the clauses 8 to 11, wherein air warmed within the nacelle by the fuel cell system provides additional propulsive trust via the Meredith effect.

Clause 13. The aircraft according to any one of the clauses 8 to 12, wherein wing surfaces of the aircraft provide additional cooling for the fuel cell system.

Clause 14. The aircraft according to any one of the clauses 8 to 13, wherein wings of the aircraft include retractable cooling fins that can be deployed during takeoff and climbing to provide additional cooling for the fuel cell system.

Clause 15. The aircraft according to any one of the clauses 8 to 14, further including a water injection system to provide humidification and/or cooling for the reactant air.

Clause 16. The aircraft according to any one of the clauses 8 to 15, further including integrated liquid hydrogen or compressed hydrogen cooling for charge air cooling, fuel cell stack cooling, or electronics cooling.

Clause 17. The aircraft according to any one of the clauses 8 to 16, further including a plurality of cooling fins for the fuel cell system that are arranged around the interior of the nacelle so that they are located in the propulsion air stream to provide cooling for the fuel cell system and also heat air in the nacelle to provide additional thrust via the Meredith effect.

Clause 18. The aircraft according to clause 17, wherein the cooling fins include ducts through which a liquid coolant circulates between the cooling fins and the fuel cell system.

Clause 19. An aircraft, including: a fuel cell system mounted within the aircraft; an electrical motor powered by the fuel cell system having a drive shaft; a thrust producing device connected to the drive shaft and configured to pressure air within a nacelle and to provide reactant air to the fuel cell system; and a bypass chamber in a nacelle configured to route a portion of air accelerated by the thrust producing device such that it bypasses the fuel cell system, wherein this air accelerated by the thrust producing device provides propulsive thrust for the aircraft as it exits the nacelle.

Clause 20. The aircraft according to clause 19, wherein the nacelle is located within a wing box or a wing root area.

Clause 21. The aircraft according to clause 19 or 10, wherein a majority of the air accelerated by the thrust producing device flows through the bypass chamber.

Clause 22. The aircraft according to clause 19, 20, or 21, wherein the nacelle is a first nacelle, the electrical motor is a first electrical motor, the drive shaft is a first drive shaft, and the thrust producing device is a first thrust producing device and wherein the aircraft further includes: a second electrical motor disposed within a second nacelle separate from the first nacelle, the second electrical motor powered by the fuel cell system and having a second drive shaft; and a second thrust producing device configured to accelerate air within the second nacelle, wherein air accelerated by the second thrust producing device provides propulsive thrust for the aircraft as it exits the second nacelle.

Clause 23. The aircraft according to clause 22, wherein the aircraft has a blended wing design.

Clause 24. The aircraft according to clause 22 or 23, wherein the first nacelle is disposed within air aircraft body and the second nacelle is disposed aft of the first nacelle.

Clause 25. The aircraft according to any one of the clauses 19 to 24, further including a liquid hydrogen storage tank.

Clause 26. The aircraft according to clause 25, wherein the liquid hydrogen storage tank is located in an aft portion of the aircraft.

Clause 27. The aircraft according to clause 25 or 26, further including a heat exchanger configured to convert liquid hydrogen to gaseous hydrogen.

Clause 28. The aircraft according to any one of the clauses 19 to 27, further including a cryogenically cooled hydrogen storage tank.

Clause 29. The aircraft according to clause 28, wherein the cryogenically cooled hydrogen storage tank is located in an aft portion of the aircraft.

Clause 30. The aircraft according to clause 28 or 29, further including a heat exchanger configured to convert cryogenically cooled hydrogen to gaseous hydrogen.

Clause 31. The aircraft according to any one of the clauses 19 to 30, further including a subcooled liquid hydrogen storage tank.

Clause 32. The aircraft according to clause 31, wherein the subcooled liquid hydrogen storage tank is located in an aft portion of the aircraft.

Clause 33. The aircraft according to clause 31 or 32, further including a heat exchanger configured to convert subcooled liquid hydrogen to gaseous hydrogen.

Clause 34. The aircraft according to any one of the clauses 19 to 23, further including a liquid methanol storage tank.

Clause 35. The aircraft according to clause 34, wherein the liquid methanol storage tank is located in an aft portion of the aircraft.

Clause 36. The aircraft according to clause 34 or 35, further including an integrated reformer configured to convert liquid methanol to gaseous hydrogen and carbon dioxide.

Clause 37. The aircraft according to clause 36, wherein heat generated by the integrated reformer is used to heat the fuel cell system during a cold start phase.

Clause 38. The aircraft according to any one of the clauses 19 to 37, further including a liquid ammonia storage tank.

Clause 39. The aircraft according to clause 38, wherein the liquid ammonia storage tank is located in an aft portion of the aircraft.

Clause 40. The aircraft according to clause 38 or 39, further including an integral reformer configured to convert liquid ammonia to gaseous hydrogen and nitrogen.

Clause 41. The aircraft according to clause 40, wherein heat generated by the integrated reformer is used to heat the fuel cell system during a cold start phase.

Clause 42. The aircraft according to any one of the clauses 19 to 41, further including a gaseous hydrogen storage tank.

Clause 43. The aircraft according to clause 42, wherein the gaseous hydrogen storage tank is located in an aft portion of the aircraft.

Clause 44. A method of operating a fuel cell system configured to provide electrical power to an electrical motor producing propulsive thrust for an aircraft, including: setting a thermostatic valve configured to direct coolant from a coolant loop to a heat exchanger producing hydrogen to a fuel cell in in bypass-open mode upon start-up of the fuel cell system, thereby bypassing a gasifying heat exchanger and, directing coolant back through the fuel cell, thus improving warm-up rate.

Clause 45. The method according to clause 44, wherein an electric hydrogen heater is modulated to provide supplemental hydrogen fuel heating power and a coolant pump in the coolant loop is modulated to augment the fuel cell warming process.

Clause 46. The method according to clause 44 or 45, further including: setting the thermostatic valve in a closed/bypass-open mode while the aircraft is taxiing on the runway in a cold ambient temperature condition and once the fuel cell has been warmed to an optimal operating temperature.

Clause 47. The method according to clause 44, 45, or 46, further including: setting the thermostatic valve in an open/bypass-closed mode while the aircraft is taxiing on the runway in a hot ambient temperature condition and once the fuel cell has been warmed to an optimal operating temperature, thus affording some heat transfer to augment hydrogen gasification.

Clause 48. The method according to any one of clauses 44 to 47, further including: setting the thermostatic valve in open/bypass-closed mode during take-off, thereby providing heat transfer for hydrogen gasification.

Clause 49. The method according to any one of clauses 44 to 48, wherein the electric hydrogen heater and the coolant pump in the coolant loop are adjusted to balance the system as desired by control system design.

Clause 50. The method according to any one of clauses 44 to 49, further including: adjusting the thermostatic valve the electric hydrogen heater, and the coolant pump in the coolant loop during level flight with low or medium load to balance the system as desired by control system design.

Clause 51. The method according to any one of clauses 44 to 50, further including: setting the thermostatic valve in the closed/bypass-open mode while descending, at low power depending in cold ambient temperature conditions, thus providing some heat transfer to augment hydrogen gasification.

Clause 52. The method according to any one of clauses 44 to 51, further including: while descending, at low power depending in hot ambient temperature conditions, setting the thermostatic valve in the open/bypass-closed mode, thus affording some heat transfer to augment hydrogen gasification.

1. A fuel cell system configured to provide electrical power to an electrical motor producing propulsive thrust for an aircraft, comprising:
a plurality of fuel cell stacks radially arranged about a central cavity and wherein fuel cell plates within each of the fuel cell stacks are oriented such that major surfaces of the fuel cell plates are parallel to an airflow created by the aircraft as it moves through the air; and
a plurality of cooling devices disposed in radial cavities located between at least two fuel cell stacks in the plurality of fuel cell stacks.

2. The fuel cell system according to claim 1, wherein the airflow is directed between the fuel cell plates to provide reactant air to the fuel cell plates.

3. The fuel cell system according to claim 1, wherein the plurality of cooling devices is configured to direct the airflow between the fuel cell plates.

4. The fuel cell system according to claim 3, wherein the cooling devices contain a coolant.

5. The fuel cell system according to claim 4, wherein a reservoir for the coolant is disposed within the central cavity.

6. The fuel cell system according to claim 4, wherein the coolant is selected from a list consisting of air, water, ice water, oil, glycol-based coolant, liquid hydrogen, and gaseous hydrogen.

7. The fuel cell system according to claim 4, further comprising a separate cooling device disposed within the central cavity.

8. An aircraft, comprising:
A fuel cell system mounted within a nacelle on the aircraft;
an electrical motor powered by the fuel cell system having a drive shaft;
an air movement device connected to the drive shaft and configured to provide reactant air to fuel cell plates in the fuel cell system; and
a propeller located external to the nacelle and connected to the drive shaft, wherein the propeller is configured to provide propulsive thrust for the aircraft.

9. The aircraft according to claim 8, wherein a plurality of air movement devices is connected with the drive shaft in common with the propeller.

10. The aircraft according to claim 9, wherein the plurality of air movement devices is selected from a list consisting of a propeller, an axial compressor, a radial compressor, and a fan.

11. The aircraft according to claim 9, wherein the plurality of air movement devices is disposed in a location selected from a list consisting of coaxial with, above, below, left, and right of the fuel cell system.

12. The aircraft according to claim 8, wherein air warmed within the nacelle by the fuel cell system provides additional propulsive trust via the Meredith effect.

13. The aircraft according to claim 8, wherein wing surfaces of the aircraft provide additional cooling for the fuel cell system.

14. The aircraft according to claim 8, wherein wings of the aircraft include retractable cooling fins that can be deployed during takeoff and climbing to provide additional cooling for the fuel cell system.

15. The aircraft according to claim 8, further comprising a water injection system to provide humidification and/or cooling for the reactant air.

16. The aircraft according to claim 8, further comprising integrated liquid hydrogen or compressed hydrogen cooling for charge air cooling, fuel cell stack cooling, or electronics cooling.

17. The aircraft according to claim 8, further comprising a plurality of cooling fins for the fuel cell system that are arranged around an interior of the nacelle so that they are located in a propulsion air stream to provide cooling for the fuel cell system and also heat air in the nacelle to provide additional thrust via the Meredith effect.

18. The aircraft according to claim 17, wherein the cooling fins include ducts through which a liquid coolant circulates between the cooling fins and the fuel cell system.

19. An aircraft, comprising:
a fuel cell system mounted within the aircraft;
an electrical motor powered by the fuel cell system having a drive shaft;
a thrust producing device connected to the drive shaft and configured to pressure air within a nacelle and to provide reactant air to the fuel cell system; and
a bypass chamber in a nacelle configured to route a portion of air accelerated by the thrust producing device such that it bypasses the fuel cell system, wherein this air accelerated by the thrust producing device provides propulsive thrust for the aircraft as it exits the nacelle.

20. The aircraft according to claim 19, wherein the nacelle is located within a wing box or a wing root area.

21-52. (canceled)
